(19) United States
(12) Patent Application Publication
(10) Pub. No.: US 2012/0114807 A1
(43) Pub. Date: May 10, 2012

(54) Casings for Foodstuffs

(76) Inventor: Peter R. Visser, Nijmegen (NL)

(21) Appl. No.: 13/347,244

(22) Filed: Jan. 10, 2012

Related U.S. Application Data
(63) Continuation of application No. 12/182,474, filed on Jul. 30, 2008, now abandoned.
(60) Provisional application No. 60/954,608, filed on Aug. 8, 2007.
(60) Provisional application No. 61/020,445, filed on Jan. 11, 2008.

(51) Int. Cl. A22C 13/00; A23L 1/315; A23L 1/212; A23L 1/317

(52) U.S. Cl. 426/105; 426/140

(57) ABSTRACT

A collagen/polysaccharide casing, and method of manufacturing the casings, are disclosed. The casings maintain their structural integrity over time and do not adversely affect the quality and taste of the encased foodstuff.

### CROSS-REFERENCE TO RELATED APPLICATIONS

This application claims the benefit of U.S. provisional patent applicant No. 61/020,445, filed Jan. 11, 2008 and U.S. provisional patent application No. 60/954,608, filed Aug. 8, 2007.

### FIELD OF THE INVENTION

The present invention relates to casings for foodstuffs. More particularly, the present invention relates to edible casings for foodstuffs comprising a collagen and polysaccharide blend, and to methods of manufacturing the casings. The present method also relates to a coextrusion method of manufacturing an encased foodstuff, such as a sausage product, having a collagen/polysaccharide casing.

### BACKGROUND OF THE INVENTION

Sausages are encased protein products providing an efficient and effective vehicle for delivering a specific quantity of a protein. Sausages also are a food of choice for quick, nutritious meals at home and in restaurants.

Sausage products are popular because they can be made from almost any protein source, cover a range of prices, and the number of flavors, sizes, shapes, and textures are essentially unlimited. Sausages can be eaten fresh or cured by smoking, cooking, dehydration, or other curing technique known in the art. The curing step provides consumer desired flavors and textures, as well as relative safety from foodborne pathogens. Cured sausages often are consumed without additional cooking. Sausages made from fresh meat products are cooked prior to consumption. Thus, all sausages must be cooked, cured, and dried, or otherwise treated to control foodborne pathogens prior to consumption.

Atypical method of producing a sausage includes grinding the protein and mixing the ground protein with salt, curing agents (if applicable), spices, flavors, sweeteners, extenders (such as milk solids, starch, cereal, and the like), and water prior to stuffing into a tubular casing. Casings can be natural or manufactured. Natural casings can be animal intestine, derived from, for example, cattle, pigs, or sheep. However, natural casings have an uneven thickness, are structurally inconsistent, and can have religious restrictions. In addition, natural casings require careful cleaning and preparation, are in short supply, and are relatively expensive. Casings also can be manufactured from polymers, such as cellulose, starch, collagen, nylon, or other natural and synthetic polymers.

If the casing material is digestible, such as collagen or various animal intestines, then the casing is consumed with the sausage. If the casing is indigestible, such as cellulose, then the casing is stripped away from the sausage prior to ingestion. An example of a sausage that is traditionally made with a casing that is stripped off prior to consumption is the “skinless” hot dog. In this case, the meat emulsion is stuffed into a cellulose casing, then the sausage is smoked, cooked, and the casing is mechanically removed prior to packing for sale.

Artificial edible sausage casings, i.e., casings not based on a natural intestine, have been made, but it has been difficult to provide a casing having a suitable degree of shrinkage when cooked, for example, by frying or boiling. During cooking, sausage meat decreases in volume up to about 15%, and it is desirable that the sausage casing shrinks by an amount sufficient to maintain contact with the sausage meat. On the other hand, casing shrinkage should not be so great that the casing splits and releases the meat during cooking. An improved casing comprising an edible fibrous collagen protein and a polysaccharide, e.g., an alginate, overcomes some of these problems.

Collagen/alginate casings comprise a continuous phase of alginate containing a network of collagen fibers. This structure is attained by extrusion of a preformed aqueous gel containing the collagen and alginate. The collagen fibers are readily extruded, aided by the lubricating action of the alginate in the extrusion die, to form a homogeneous, strong casing.

Casings manufactured from collagen alone or a polysaccharide alone have disadvantages. Extruded collagen casings can be difficult to manufacture, can be difficult to eat, and tend to shrink excessively during frying, thereby splitting and releasing the meat. Casings made solely of alginate have not been commercially developed and are subject to inherent calcium alginate instability issues.

By blending the two materials before coextrusion, a mixture results wherein the undesirable extrusion properties of the collagen are modified by the alginate and the undesirable properties of the alginate are modified by the collagen. For example, the resulting casing is desirable because it shrinks with the meat during cooking, but not to such a degree that the casing splits or extrudes the meat through the sausage ends. In addition, the resulting casing is more compatible with the protein-based meat emulsion because it has a protein content, and exhibits more resistance to thermal processing, i.e., cooking, than an alginate casing.

Collagen is an abundant animal protein present in animal connective tissue, skin, cartilage, bone, and tendons. Because collagen is digestible and absorbable by the human body, it finds use in a variety of medical uses, such as absorbable sutures or injection under the skin to remove wrinkles and provide a fuller, smoother, more youthful appearance. Because of its digestibility, collagen also is extensively used by the food industry, for example, as a casing for edible food products.

Collagen used in the encasement of food products typically is recovered from bovine and other animal skins by well-known processes. Other sources of collagen include, but arc not limited to, bones, tendons, and intestines. The typical process for producing commercial collagen uses the corium layer of animal hides, known in the art as “hidesplits.” Hidesplits are washed, optionally chemically treated to reduce natural crosslinking levels, and finally acid softened. The softened hidesplits are converted to a stable, pumpable gel by various operations, including, but not limited to, grinding, milling, and homogenization. Various processing aids that improve collagen casing properties can be added during this converting process.

The product of this process is an aqueous gel-like material containing 3% to 7%, by weight, collagen solids and a pH of about 2 to about 4. This type of collagen is termed “acid collagen,” and is commonly used to produce a shaped, tubular casing for the production of a variety of sausage products, such as pork breakfast sausages, ring bologna, bratwurst, hot dogs, chorizo, and related products. The collagen casing is edible and fully digestible.

There are other methods of using collagen for the encasement of sausages. It is known to coextrude a strand of sausage having (a) an inner core of ground, comminuted meat and (b) an outer surface material that can be coagulated to provide a casing for the strand of ground meat. The outer surface material can be a collagen gel protein. Coagulation of the casing typically includes subjecting the extruded strand to a brine solution. The resulting sausages therefore are drawn, drenched, or sprayed with a salt bath to dehydrate and harden the collagen casing. The brine is applied immediately after the strand is extruded.

For many reasons, a collagen encasement is not suitable for all types of sausages. In particular, the dehydrating bath used to stabilize, strengthen, and harden the collagen-encased sausages also draws water from the meat product within the collagen casing. When cooked or cooked/smoked meats, such as hot dogs, bratwurst, chorizo, and ring bologna, are coextruded with a collagen encasement, they are immediately drawn through a stabilizing salt bath that contains sodium, potassium, or calcium salts, such as chlorides, nitrates, phosphates, sulfates, and the like. These aqueous salt solutions are referred to in the art as “brine.”

When the encased sausage is contacted with a brine solution, water is drawn from the collagen casing, thereby effectively densifying the collagen polymer chains and creating a stable, hardened structure that holds and protects the sausage. The syneresis effects of the brine also can draw water from the inner core of meat or meat emulsion. If the particular sausage being produced is a type that allows incorporation of additional quantities of water, the additional water is not harmful because the resultant sausage can withstand a degree of dehydration during the encasement hardening procedure. In some embodiments, dehydration actually may provide benefits.

However, this is an undesirable effect for sausage products that permit only a few percent of water to be added to the meat during processing because any water that is drawn from the meat during hardening of the casing results in diminished profitability. Thus, in developing a coextrusion process for these types of sausage products, a method different from dehydration is used to harden and stabilize the sausage casing.

One example of a sausage wherein a different type of casing stabilizing, or hardening, is necessary is termed “fresh sausages”, which are cooked by the consumer just prior to consumption. Fresh sausages can be frozen or unfrozen. Examples of this type of sausage product are fresh breakfast, pork, beef, and turkey sausages. As used in the art, the term “breakfast sausage” indicates that meat by-products may be present, while “pork, turkey, and beef” indicates that only skeletal muscle is present.

The standard for fresh sausages is very strict and only small amounts of water, i.e., up to 3%, can be added. Thus, when producing fresh sausages, the hardening and stabilizing process for the collagen casing cannot involve dehydration or air drying, and a different means stabilization must be used. It is possible to admix a hydrocolloid with collagen such that the hardening, stabilization step does not require dehydration. Such an admixture is stabilized by a chemical process not involving dehydration, syneresis, and air drying.

Hydrocolloids are polymers that gel by absorbing water and are a natural choice for use alone or with collagen to form a casing. Examples of hydrocolloids are polysaccharides, such as natural gums, like gum acacia, gum Arabic, carrageenan, alginic acid, and salts thereof. In addition, many water-soluble polymers, such as polyvinyl alcohol, polyacrylic acid, and the like, and some starches and modified starches, also can form gels when contacted with water. The preferred hydrocolloid is sodium alginate, which rapidly forms strong gels when contacted with multivalent metal cations such as, but not ed to, calcium, barium, aluminum, magnesium, and the like.

Alginates are salts of alginic acid, which is derived from seaweed. Alginates are carbohydrate polymers composed of two epimeric monomers, alpha-(1,4)-L-guluronic and beta-(1,4)-D-mannuronic acids. Due to their high carboxyl and hydroxyl group content, alginates crosslink and gel when contacted with multivalent metal cations. For food-related uses, calcium ion is the multivalent cation of choice.

Crosslinking of alginates by metal ions bridges two reactive sites, for example, an acid group and a hydroxyl group, in the same alginate chain or in different alginate chains. Therefore, treatment of a sodium alginate with an aqueous solution containing multivalent metal cations produces strong gels.

When the sodium alginate is admixed with an aqueous collagen gel in certain proportions, the entire mass gels and becomes film and stable. The addition of an alginate to collagen presents a problem because a collagen gel typically is acidic having a pH in the range of 2.1 to 3.4. Alginates, however, are primarily carbohydrates containing numerous glycosidic bonds which are not stable in acidic environments. Accordingly, the alginate degrades when admixed with acid collagen. This problem can be resolved by a partial neutralization of collagen acidity to raise the pH to about 3.8 to 5.5. In this pH range, the collagen and alginate gel does not degrade, and the collagen/alginate gel rapidly hardens and stiffens when contacted with a solution containing multivalent metal ions. Calcium salts are a preferred choice for this step because they are readily available, approved for food use, and inexpensive. For example, the gelling reaction occurs rapidly and thoroughly within several seconds of contact with a 5-30%, by weight, calcium chloride solution. Sodium alginate alone performs similarly.

A serious problem resulting from a collagen/alginate gel is migration of the multivalent metal ion from the hardened and set casing into the meat product of a sausage. In particular, the multivalent metal ion, typically calcium, migrates from the casing and is replaced by sodium ions migrating from the meat. This transfer of sodium for calcium in the casing breaks the alginate crosslinks of the casing, and the structural integrity of the casing is impaired or destroyed.

Persons skilled in the art have tried various methods of overcoming this migration of metal ions. One method is to use an excess amount of calcium ions in the alginate crosslinking step. Alternatively, the meat product can be loaded with calcium ions. This method provides a calcium sink in the casing or the meat such that sufficient calcium ions remain in the casing to provide crosslinks. However, using excess calcium ions, in the form as a salt, such as calcium chloride, can adversely effect the taste of the meat in the sausage.

Another method to reduce metal ion migration is to reduce the water activity of the casing. In accordance with this method, materials such as modified cellulosics and starches were added to alginate or the collagen/alginate blend, as were propylene glycol, polypropylene glycol, glycerin, and other oils and emulsified waxes. The addition of such a material provided an improvement in desirable properties. However, the improvement was insufficient to provide a commercially acceptable product.

The present invention is directed to overcoming problems associated with casings prepared from a collagen/polysaccharide gel, including the migration of multivalent metal ions from the casing into the meat, the loss of structural integrity of the casing, and the growth of microbes in the casing.

### SUMMARY OF THE INVENTION

The present invention is directed to a method of preparing a casing for a foodstuff from an aqueous gel comprising a collagen and a polysaccharide. More particularly, the present invention is directed to a method of preparing a casing for a foodstuff from a blend of collagen and an alginate. The present invention is further directed to a casing prepared by the methods disclosed herein, and to foodstuffs comprising an extruded meat product encased in a collagen/polysaccharide casing of the present invention.

In accordance with the present invention, the method provides a casing that resists degradation over time such that the structural integrity of casing is maintained over extended time periods. Therefore, one aspect of the present invention is to provide an improved casing for a foodstuff comprising a collagen and a polysaccharide, such as an alginate.

Another aspect of the present invention is to provide a casing for a foodstuff from an aqueous collagen/polysaccharide gel wherein about 10 to about 1500 ppm, by weight, of a aminopolycarboxylic acid, or salt thereof, is present in the gel.

Still another aspect of the present invention is to crosslink and set the collagen/polysaccharide gel to form a casing by contacting an extruded gel with a solution of a salt of a multivalent metal, such as calcium, preferably wherein the anion of the salt comprises an organic anion, i.e., a carboxylate anion, such as lactate or citrate.

Another aspect of the present invention is to provide a collagen/polysaccharide casing that resists or eliminates leaching of calcium ions from the casing into the encased foodstuff, without adversely affecting the encased foodstuff.

Yet another aspect of the present invention is to provide a collagen/polysaccharide casing that maintains its structural integrity for at least six months.

These and other novel aspects of the present invention will become apparent from the following nonlimiting detailed description of the preferred embodiments.

### DETAILED DESCRIPTION OF THE PREFERRED EMBODIMENTS

A collagen/polysaccharide casing of the present invention is prepared by admixing an aqueous slurry of collagen fibers and a polysaccharide, e.g., an alginate, to form a gel, extruding the resulting gel to the desired form, and then setting or hardening the gel, typically by use of a multivalent metal ion precipitating agent, e.g., calcium, for the alginate such that the form of the casing is retained.

A general method of making collagen/polysaccharide casings according to the present invention is as follows. A source of collagen is washed, then minced and milled, to provide an aqueous paste in which collagen fibers are dispersed to a desired degree. During this process, the temperature of the collagen typically is maintained below 40° C., and preferably below 25° C., to minimize protein denaturation. The sodium alginate then is milled with the collagen, and the resulting mixture is homogenized to shear the collagen bundles to the desired dimensions. This process also promotes chemical and physical interactions between the collagen and the alginate.

The collagen/alginate gel then is extruded through a suitable annular nozzle into a setting solution. A particularly suitable setting solution contains di- or trivalent metal ions which precipitate the alginate as an insoluble salt. A preferred setting agent comprises calcium ions. In one embodiment, the formed casing then is inflated by air to assist in further processing and, after washing to remove excess setting solution, the casing is dehydrated to a moisture content of about 10% to about 50%.

More particularly, the method of preparing collagen/polysaccharide casings is performed as follows. Trimmed cattlehide tannery splits are treated, for example, with calcium hydroxide at a pH of 12 or greater to control microbes, then refrigerated. The treated splits are treated with calcium ions, which then are thoroughly rinsed from the splits. The splits next are neutralized to a pH less than 7 with acetic acid. The excess acetic acid is removed, and the neutral hides are saturated with sodium sulfate. Sodium hydroxide then is added to deamidate the collagen, followed by neutralization with acetic acid to pH less than 7. The resulting sodium acetate is rinsed from the hides, which then arc treated with lactic acid and acetic acid to soften and swell the hides, i.e., put the hides in a condition for grinding.

Collagen typically has an amide nitrogen number of about 2.8 (calves and other young animals) to about 3.2 (in adult and older animals). In accordance with the present invention, the amide nitrogen number of the collagen is reduced by a deamidization process, such as, a sodium hydroxide treatment, to about 1.0 to about 2.2, i.e., 1.0, 1.1, 1.2, 1.3, 1.4, 1.5, 1.6, 1.7, 1.8, 1.9, 2.0, 2.1, and 2.2, and all ranges and subranges therein. Preferably, the amide nitrogen number is about 1.1 to about 2.1, and more preferably about 1.2 to about 2.0. A reduction in amide nitrogen number provides a stable collagen/polysaccharide gel, which in turn provides a stable collagen/polysaccharide casing for a foodstuff.

In some embodiments, a crosslinker is added to the collagen prior to formation of the collagen/alginate gel. The optional crosslinker can be any compound having at least two functional groups. The crosslinker crosslinks the collagen protein with itself, and also potentially with the alginate, and thus increases the stability and strength of the casing. The addition of a crosslinker raises the melting point of the collagen and imparts strength to the collagen. Several different crosslinkers are useful, and are compounds having multiple reactive sites, particularly reactive sites that readily react with nitrogenous and/or hydroxyl moieties. The optional crosslinker can be a diacid, diester, diamine, diepoxy, diacryl chloride, dihalide, or anhydride compound, or a compound having at least two of such functional groups, either the same or different. Additional crosslinkers include, but are not limited to, phosphorous oxychloride and polyphosphates. Typically, the crosslinker is a dialdehyde, e.g., glyoxal, or a hydroxyaldehyde, e.g., a hydroxyacetaldehyde. An example of a useful crosslinker is glutaraldehyde.

The preferred crosslinkers are dialdehydes, which can be derived from the pyrolysis of an organic material, such as sawdust or carbohydrates. Accordingly, a crosslinker can be added to a collagen gel in the form of a liquid smoke product, available for example from Red Arrow Products Co., LLC. Liquid smoke is a very complex mixture of carbonyl containing compounds, such as formaldehyde, glycolic anhydride, glyoxal, acetone, hydroxyacetone, methylglyoxal, diacetyl, and furfural; phenols, primarily phenol, guaiacol, syringol, m-cresol, 4-methylguaiacol, and iso-gugenol; and organic acids, primarily acetic acid. The carbonyl containing compounds of a liquid smoke product serve as efficacious and low cost crosslinkers. Preferably, the liquid smoke product is low in taste and odor so as to avoid adversely affecting the meat product encased by the collagen. The liquid smoke composition can he treated with hydrogen peroxide to reduce taste and odor attributed to the liquid smoke composition. Commercial examples of crosslinkers include MAILLOSE®, available from Red Arrow Products, LLC, Manitowic, Wis., and the Kymene products. MAILLOSE® contains hydroxyacetaldehyde, a particularly effective crosslinker.

The optional crosslinker is present from 0 to about 5000 ppm, and typically 10 to about 3,000; 20 to about 2,500; 30 to about 2000; 40 to about 1500; or 50 to about 1000 ppm, based on the weight of the collagen.

The treated hides are reduced to a collagenous paste by passing through a high-speed mincer, and then passed a plurality of times through a colloid mill set to progressively finer clearance, the last typically being a 0.35 mm gap. The collagen is cooled during milling, and the collagen paste so obtained then is mixed with sodium alginate, first in a disintegrator and then in a colloid mill. The mixture is deaerated, then extruded through an annulus to form a casing.

The collagen/alginate casing is set by a bath containing an aqueous calcium salt solution, which contacts both the inside and outside surfaces of the casing. After passing from the setting solution, the casing is inflated using pressurized air. The inflated casing is drawn away from the nozzle and washed with water.

Lengths of the casing are wound in an open spiral round a reel, inflated, and dried in a current of air. The casings then are transferred for conditioning to a humidity cabinet maintained at 85% relative humidity and 20° C. After the casing reaches an equilibrium moisture content of 30 to 35%, the casing is spooled and is ready for shining and stuffing with sausage meat. Preparation of collagen/polysaccharide casings also is disclosed in GB 1,040,770.

The above method describes the preparation of a preformed collagen/polysaccharide casing that is stuffed with a meat product at a later date. The present casings also can be prepared using a coextrusion method wherein a collagen/polysaccharide gel is extruded over the meat product, as the meat product is being extruded. The casing then is set on the meat product by contacting the extruded with a solution of polyvalent metal, e.g., calcium, ions.

In the coextrusion method, the polysaccharide can be used in any weight ratio of polysaccharide to collagen, i.e., 100:0 through 0.1:99.9, and all ratios therein. However, a casing preferably contains a greater weight fraction of collagen than polysaccharide. When used in such weight ratios, the resulting casing maintains its structural strength for a longer time. Preferably, the weight fraction of collagen in the collagen/polysaccharide blend is 1.2 times greater than that of the polysaccharide. It is more preferable when the collagen weight fraction is 1.5 times greater, even more preferable when more than two times greater, and most preferable when the weight fraction of collagen in the collagen/polysaccharide blend is more than 2.5 times greater than that of polysaccharide.

Coextrusion of the collagen/polysaccharide gel with the meat product preferably is performed using a counter rotating extrusion head that assists the natural polymer system to orient in a direction transverse to the extrusion direction. With the use of such an extrusion head, the gel in its plastic state is subjected to shearing forces during the coextrusion process. Extrusion of the casing for a foodstuff product is performed using an extrusion head containing a moving component that rotates at an angle to the extrusion direction and comes into contact with the casing product. This design for an extrusion head subjects the gel to shearing forces in a direction that is transverse to the extrusion direction. These shearing forces work in the direction of the extrusion process, and also transversely to the extrusion process. As a result, the collagen fibers, if present, are forced into mutually opposite directions which increases the number of crossing fibers, and in turn greatly increases casing strength and durability.

Although collagen/polysaccharide casings are known, and coextrusion of a collagen/polysaccharide gel with a meat is known, these casings have disadvantages that limit their commercial use. One problem is the migration of calcium ions from the casing into the encased meat, which adversely affects the structural integrity of the casing. Another problem is the salty taste imparted by a high concentration of calcium chloride. The present invention is directed to overcoming these disadvantages.

As stated above, a present casing contains a collagen and a polysaccharide. Collagen is a fibrous selero protein, and is the preferred fibrous protein for use in the present invention. However, it should be understood that another fibrous protein, such as a keratin or an elastin can be substituted for the collagen, either in part or in whole.

The weight ratio of collagen to polysaccharide in the blend preferably ranges from about 90:10 to about 30:70, and preferably about 80:20 to about 40:60, or about 70:30 to about 50:50, on a dry weight basis. The actual preferred blend of collagen and polysaccharide contains about 2% to about 7%, preferably about 3% to about 6%, and more preferably about 3.5% to about 5.5%, by weight, of the collagen. The blend also contains about 1% to about 5%, and preferably about 2% to about 4%, by weight of the polysaccharide. The remainder of the blend is primarily water, pH-adjusting agents, and ingredients disclosed below.

The polysaccharide typically is an alginate, although other polysaccharides, such as pectic acid having carboxyl groups can be used in place of an alginate, in part or in whole.

Alginates are carbohydrate polymers composed of two epimeric monomers, alpha-(1,4)-L-guluronic and beta-(1,4)-D-mannuronic acids, which are designated as “G” and “M”, respectively. The G and M forms are termed epimers because they differ only in the conformation of the glycosidic linkage connecting the sugar monomers. Thus, three possible monomeric combinations exist in the polymeric alginate chains, i.e., GGGG, MMMM, and GMGM, and, in fact, polymer chains of alginate contain regions of all three.

Alginates crosslink and gel when contacted with multivalent metal ions, such as, but not limited to, calcium, barium, aluminum, magnesium, strontium, and the like. For food-related uses, calcium ions are the preferred crosslinking metal ions. Alginate regions conformationally structured to receive calcium ion as a crosslinking cation occur in the GGGG regions. Polymeric chains that are high in MMMM or GMGM do not participate in the crosslinking reaction.

Polymers that are high in MM form weak hydrogen bonds between the terminal hydroxyl groups and the subsequent ring oxygen, whereas hydrogen bonds that form in high GG alginates occur between the carboxyls and the hydroxyl group, of another monomer unit. When two polymer chains interact between their GG regions, the chains sit on top of one another and form a void in which the calcium ion fits. Adding calcium ions to a sodium alginate solution induces this type of dimeric association.

High G alginates produce strong brittle gels with good heat stability, but they are prone to syneresis in freeze-thaw cycles. High M alginate gels have good freeze-thaw stability, but the gels are weaker and more elastic. Preferred alginates therefore contain a high level of the G monomer in the polymer.

In accordance with an important feature of the present invention, the aqueous gel of the collagen and polysaccharide contains an aminopolycarboxylic acid, such as ethylenediaminetetraacetic acid (EDTA) or similar aminopolycarboxylic acid suitable for being added to, or in contact with, a foodstuff. Other useful aminopolycarboxylic acids include, but are not limited to, nitrilotriacetic acid (NTA), diethylenetriaminepentaactic acid (DTPA), N-hydroxyethylethylenediaminetriacetic acid (HEDTA), N-dihydroxyethylglycine, ethylenebis-(hydroxyphenylglycine), salts thereof, and mixtures thereof.

The aminopolycarboxylic acid is present in the aqueous gel of the collagen and polysaccharide in an amount of about 10 to about 1500, and preferably about 100 to about 1300 ppm, by total weight, of the collagen/polysaccharide gel. In more preferred embodiments, the aminopolycarboxylic acid is present in an amount of about 200 to about 1200 ppm, about 300 to about 1200 ppm, about 400 to about 1150 ppm, or about 500 to about 1100, by total weight of the gel.

As demonstrated below, the presence of an aminopolycarboxylic acid in the collagen/polysaccharide casing retards migration of crosslinking calcium ions from the casing into the encased meat product. Retarding or eliminating the migration of calcium ions retains the structural integrity of the casing, maintains the quality of the meat product, including taste, and maintains the “bite” characteristics of the encased foodstuff.

It is important to overcome the problem of calcium migration in alginate-containing casings. When ground fresh sausage is coextruded with a collagen/alginate gel as the casing, and the so-produced sausages are contacted with a calcium ion containing aqueous solution, a firm casing develops and surrounds the sausage almost instantaneously. The casing is sufficiently strong to permit the further processing and packaging encountered in a commercial process. When immediately fried on a grill or other heated surface, such as a frying pan over a burner or a grill, to an internal temperature of about 165° F., the sausage maintains its shape and structure and compares favorably to a sausage produced by stuffing fresh sausage into collagen casing.

However, when a sausage that has been produced by the coextrusion process from a collagen/polysaccharide gel is allowed to remain in the defrosted, or “slack,” state for more than about two hours, frying thermal processing, i.e., cooking the skin to soften and otherwise degrade, and the resulting cooked sausage is not acceptable. It is highly stippled, has no remaining skin, leaves a heavy residue on the heat source, and often simply falls apart when turned during the normal course of frying. The yield also is often unacceptably low. However, if a similarly slacked sausage is dipped into a calcium ion bath for as little as two seconds, the protective casing is reestablished and has adequate frying properties.

While not being bound by any theory, this observation suggests that collagen/alginate encased sausages fail because the calcium ions that harden and set the collagen/alginate gel migrates into the stuffed meat and the sodium ions present in the meat migrate back into the alginate. This removes calcium ions from the alginate, and the alginate is no longer sufficiently crosslinked, which weakens the encasement. When the same sausages are again contacted by a calcium bath, the alginate crosslinks are reestablished and the entire gel mass firms and stabilizes to form a protective casing.

For an alginate-based coextrusion gel to perform in afresh sausage application, the gel must cold-form into a strong and stable protective casing. A loss of protective ability by the casing after remaining under slack conditions for a short time is a serious impediment to commercial viability. If alginate alone is used, in the absence of collagen, the freshly coextruded products may fail because the alginate film structure, weakened by calcium migration, may fracture when the sausages are cooked.

The theory of calcium transport is readily understood by considering that two phases exist in an alginate or a collagen/alginate casing. Although, the phases may not be totally discrete, a mobile phase and an immobile phase coexist. The immobile phase is the collagen and alginate, and the mobile phase is aqueous. Unbound calcium ions preferentially reside in the aqueous mobile phase and are readily available for migration and transport to the meat emulsion. Thus, because of equilibrium phenomena in both the sequestering of calcium ions and the concentration of calcium ions in the aqueous phase, equilibrium-controlled unbound calcium ions migrate from the aqueous phase into the encased meat. This perturbs the calcium ion equilibrium and causes additional calcium ions to leach from the alginate polymer, which then are transported to the encased meat. This process continues until sufficient calcium ions are removed from the casing such that the casing loses structural integrity and fails the frying test.

Therefore, calcium ion migration from the alginate into the encased meat phase must be significantly retarded or eliminated. This is difficult to accomplish. For example, fresh sausage has a very strict USDA code of identity such that direct addition of materials to the meat that may retard the transport of the calcium ions across the casing/meat barrier is not possible. In addition, if materials are added to the collagen, they must be inexpensive, lack taste, odor, color, and flavor, be readily available, and also be FDA approved for direct addition to food.

In accordance with an important feature of the present invention, it has been found that the addition of a sequestering agent, such as EDTA, retards the migration of calcium ions from the casing to the meat. Further improvements were gained by including additional optional ingredients in the collagen/polysaccharide gel.

For example, in addition to collagen, alginate, and water, the gel prior to extrusion can contain a polyol suitable for use in a foodstuff. Examples of useful polyols include, but are not limited to, propylene glycol, a polypropylene glycol, glycerin, or mixtures thereof. The polyol imparts additional plasticizing properties to the casing under cooking conditions, thereby preventing the encasement from becoming too brittle and minimizing splitting and breaking. The amount of polyol in the alginate or collagen/alginate gel is sufficient to account for 0% to about 50%, and preferably about 5% to about 45%, by weight of casing solids. In more preferred embodiments, the polyol is present in an amount of about 10% to about 45%, or about 15% to about 45%, or about 20% to about 40%, or about 25% to about 40%, by weight of the casing solids.

The collagen/alginate gel also can contain 0% to about 5%, preferably 0.5% to about 4%, and more preferably about 1% to about 3%, by weight of casing solids of an oil. The oil can be mineral oil or a natural oil, and also imparts hydrophobicity to the casing. Nonlimiting examples of natural oils are the edible oils, such as soy oil, corn oil, coconut oil, castor oil, palm kernel oil, peanut oil, rape seed oil, canola oil, olive oil, rice bran oil, beef tallow, sunflower oil, oat oil, palm oil, and similar oils.

The collagen/alginate gel also can contain cellulose or a modified cellulose in an amount of 0% to about 2.5%, about 0.1% to about 2.5%, about 0.25% to about 2%, about 0.3% to about 1.5%, about 0.4% to about 1.25%, or about 0.5% to about 1%, by weight of casing solids. The cellulose material imparts moisture permeability properties to the casing, and modified cellulose increases the viscosity of the alginate or collagen/polysaccharide gel. Nonlimiting examples of the cellulose material include microcrystalline cellulose, sodium carboxy methylcellulose, carboxy methylcellulose, hydroxybutyl methylcellulose, hydroxyethyl ethylcellulose, hydroxypropylcellulosc, hydroxyethyl methylcellulose, methylcellulose, hydroxypropyl methylcellulose, hydroxyethylcellulose, and mixtures thereof.

These optional materials, and the aminopolycarboxylic acid, are added to the aqueous collagen/polysaccharide gel at an appropriate time prior to extrusion.

It now has been found that using a calcium lactate bath, or a similar calcium salt bath, to set the collagen/polysaccharide casing helps address the problem of pathogen growth. As discussed above, the collagen/polysaccharide casing is set immediately after extrusion by contact with a calcium salt solution. The source for calcium ions typically is calcium chloride because calcium chloride is inexpensive and highly soluble in water. However, calcium chloride has some disadvantages. For example, calcium chloride can impart a salty taste to the meat, especially if high levels of (>5%) calcium chloride are used, either in the casing or in the meat, in an attempt to overcome the migration of calcium ions from the casing to the meat.

In accordance with an important feature of the present invention, the calcium ion source for setting the collagen/polysaccharide gel comprises calcium lactate and/or a similar calcium salt, such as calcium citrate. Substitution of calcium chloride by another calcium source was not a simple proposition. The substitute material must be approved by the FDA for direct addition to food, readily available, and relatively cost effective, in addition to having a low taste profile. Calcium lactate solved this problem because calcium lactate is virtually tasteless and meets all other requirements for food casing.

In particular, in this embodiment of the present invention, the calcium source comprises a water-soluble calcium salt of a carboxylic acid, i.e., a water solubility of at least 0.1 grams of the salt per 100 grams of water at 25° C. The preferred calcium salt comprises calcium lactate. The calcium lactate can be the sole calcium ion source, or can be used with other calcium compounds, like calcium chloride. Calcium lactate is sufficiently soluble in water to provide a viable setting solution. Importantly, calcium lactate also retards the growth of pathogens in the casing and does not impart a hitter, salty taste to the encased meat.

It also should be noted that other calcium salts of an organic carboxylic acid can be used as the calcium ion source, either alone, in combination with calcium lactate, or in combination with one another. Other useful calcium salts, for example, are calcium citrate, calcium lactate gluconate, and calcium acetate.

To demonstrate the new and unexpected benefits provided by the present invention, a series of statistically designed experiments was conducted. Statistical experimental design experimental design allows an analysis of several variables in the fewest number of experiments by fitting the experiments to a geometric space circumscribed by the limits of each variable. The results are analyzed by “analysis of variance”, or ANOVA, which yields linear equations for each dependent variable in terms of all of the independent variables. The results of these experiments clearly demonstrated that, totally independent of the taste parameter, calcium lactate unexpectedly exhibited optimal performance compared to calcium chloride. In addition, when EDTA was included in the collagen/alginate gel, the unexpected results were even more dramatic.

The most important physical parameters required for a commercial sausage were determined to be % yield after frying, griddle solid residue, and bite. The first two parameters are self explanatory. “Bite” is an organoleptic property that relates to the snap, or mouthfeel, a consumer experiences upon biting into a food product. For example, the experience of biting into a pudding is different from the experience of biting into an apple, i.e., the apple exhibits a significant “bite”. Each food product, in every culture, has a desired “bite” associated with the food product. For example, an English “banger” sausage has a firm “bite”, whereas in the United States, a preferred hotdog has a softer “bite”. Fresh pork sausages, made with collagen casings have a medium firm to firm “bite”. One of the greatest challenges in producing commercial fresh pork breakfast sausages is providing the desired “bite”. The “bite” of a commercial sausage is related to the degree of casing crosslinking, which in a collagen/polysaccharide casing is related to migration of calcium ions into the foodstuff Retarding or eliminating the migration of calcium ions from the casing enhances the “bite” of a product.

Table 1 summarizes preferred embodiments of a polysaccharide or collagen/polysaccharide casing made in accordance with the present invention.

TABLE I

| | | More | |
|---|---|---|---|
| | Preferred | Preferred | Most Preferred |
| Total Solids (%)^{a)} | 5-9.5 | 6-9 | 7-8.5 |
| “G” Level in Alginate | 15-65 | 25-60 | 30-50 |
| %^{b)} | | | |
| Casing Layer (% of | 3.5-10 | 4.5-8 | 5-7.5 |
| Product Weight)^{c)} | | | |
| EDTA (ppm)^{d)} | 10-1500 | 400-1200 | 750-1100 |
| Glycerin (%)^{e)} | 0-50 | 15-45 | 25-40 |
| Calcium Ion Source | Calcium | Calcium | Calcium lactate |
| | halides, nitrate, | chloride, | |
| | sulfate, | calcium lactate | |
| | phosphate, | | |
| | lactate, | | |
| | salicylate | | |
| Cellulose (%)^{f)} | 0.10-2.5 | 0.25-1.50 | 0.50-1.0 |

^{a)}% by weight solids in the gel prior to extrusion;
^{b)}% “G” monomer in the alginate;
^{c)}% by weight of the casing of the encased foodstuff;
^{d)}Amount of EDTA in the gel;
^{e)}% by weight glycerin expressed as casing solids; and
^{f)}% by weight cellulose expressed as casing solids.

The following collagen/alginate gels were prepared, then extruded and set to form a casing. The resulting casings were tested for acceptability in use as a commercial casing.

The important physical parameters that must be met to commercialize a sausage are % yield after frying, griddle solid residue remaining after frying, and “bite”. These parameters are described above.

Experimental Procedures

Measurement of % yield, residue, and “bite”

A flattop Teflon coated electric grill, measuring 28×12 inches was heated to 325+/−5° F., or measured by a hand held infrared probe. The griddle surface was visually divided into halves and six preweighted sausages were placed in the center of each section, then fried for 13 minutes with turning every 30 seconds. At the end of this time, the internal temperature of the sausages was 160+/−3° F. The % yield was calculated from the weights of the six sausages by dividing their weights before and after frying. Residue was measured as the % of the area covered by the six sausages during frying on a flattop grill. A 10 rating was assigned to a sausage that left no residue and if about 60% or 90% of the area was covered by residue after the frying test, then a rating of 4 or 1, respectively was assigned to those sausages. The “bite” was rated on a scale of 1-10, with 1 being the softest “bite” and 10 being the firmest “bite”. For example, a 5 “bite” has a pleasant snap when bitten, and would not be construed as tough. A “bite” of 8 or higher is construed as tough, and a “bite” of 3 or less is construed as mushy.

The collagen/alginate gel used in the present examples was prepared as follows:

Collagen Preparation

Bovine hide splits were treated with calcium hydroxide to a pH greater than 10 to provide antimicrobial protection, then water washed to remove excess calcium hydroxide. Next, an acetic acid solution was added to neutralize the remaining calcium hydroxide while maintaining the process temperature at less than 25° C. Neutralization salts then were removed from the hide splits by water washing. The neutralized, washed hides were treated with a saturated sodium sulfate, then sodium hydroxide solution (1M) and sodium sulfate to adjust the amide nitrogen number of the collagen from about 2.8 to about 3.2 down to about 1.0 to about 2.0, then neutralized, water washed again, and lactic acid was added, which was absorbed into the collagen for softening and preparing the collagen for further mechanical processing, such as grinding. The ground collagen then was mixed with water, cellulose, and sodium benzoate in a mixing step, using a sigma blade mixer. The resulting pH standardized mixture was processed through multiple high intensity, shear mixing to form a stable aqueous collagen gel suitable for further processing.

Method of Determining the Amide Nitrogen Number of a Collagen Reagents:

0.05M sodium tetraborate/0.15N sodium hydroxide: Dissolve 19.1 grams reagent grade sodium tetraborate decahydrate and 6.0 grams reagent sodium hydroxide in one liter of distilled water and mix well.

Mixed indicator solution: Mix equal volumes of 0.033% reagent methylene blue in reagent ethanol and 0.05% reagent methyl red in reagent ethanol.

1% Boric acid with indicator: Dissolve 10.0 grams reagent boric acid in one liter of distilled water. Then, add 8.0 ml of the mixed indicator solution. Finally, adjust this solution to a neutral gray color by adding about 0.7 ml 0.1 N NaOH.

2N HCl.

2N NaOH

0.02N HCl

0.10N NaOH

Procedure:

Accurately weigh 2.5 grams of ground hide splits or 25 grams of collagen gel into a 250 ml round bottom flask. Add a dozen boiling chips and 100 ml of 2N HCl. Place the flask in a heating mantle and connect to a vertical cold water condenser. Heat and reflux the solution for one hour. Then remove the heating mantle and allow the solution to cool to room temperature.

Pour the cooled, digested collagen HCl solution into a 400 ml beaker. Place the beaker on a stir plate and add a stir bar. Stir the contents and add about 1 ml of the mixed indicator solution. The solution should be red-pink in color. Then, add 2N NaOH first in 10 ml portions, and later in smaller increments, to the gray-green endpoint of the indicator. Approximately 80-120 mls of 2N NaOH will be required. Then, pour this solution into a 250 ml volumetric flask and dilute to the mark with distilled water. Invert the flask multiple times to mix well.

Accurately measure 100 ml from the 250 ml volumetric flask and add to a 500 ml round bottom flask. Then, add 100 ml of the tetraborate reagent to the 500 ml round bottom flask with a dozen boiling chips. Distill this solution and collect the first 75 ml of distillate into a 250 ml round bottom flask that initially contained 25 ml of the 1% boric acid with indicator reagent solution.

Pour the 100 ml from the distillation receiving flask into a 250 beaker, place on a stir plate with stir bar, and add 1 ml of the mixed indicator solution. The solution should be greenish blue in color. Then quantitatively titrate the solution dropwise with the 0.02N HCl to the gray-red endpoint. Record the quantity of titrant needed.

Calculate % Amide Nitrogen according to the following formula:

% AN=((ml HCl)(normality HCl)(14.007)(2.5)(100%))/(initial sample weight in milligrams),

wherein 14.007 is the molecular weight of nitrogen and 2.5 is the factor of using 100 ml of the 250 nil of neutralized digested collagen.

Gel Preparation

The aqueous collagen gel was added to a high intensity, high shear mixing operation, such as a bowl chopper. Gel pH was adjusted to 4.0-4.1, then a crosslinker, EDTA, glycerin, and oil were blended into the collagen gel. Solid alginate then was added in the appropriate amount, and with high intensity shear mixing dispersed and dissolved into the aqueous collagen gel. This step required multiple mixing and rest cycles to successfully disperse, wet, and then dissolve the alginate to form a stable dispersion. The pH was controlled at less than 5.5, preferably at less than 4.8, or 4.7, but above 3.9. Most preferably, the pH is maintained between 4.1 and 4.7. The resulting alginate/collagen dispersion then was subjected to an additional high intensity, high speed milling operation to ensure dispersion stability. The temperature was maintained at less than 25° C. to prevent degradation of the collagen.

Preparation of Sausages

The alginate/collagen gel dispersion then was utilized in coextrusion equipment, similar to a Townsend QX Coextrusion system. The meat and alginate/collagen gel were coextruded into a sausage “rope,” and regenerated by exposure for 1-60 seconds to a calcium cation brine solution. The sausage then was crimped and cut to desired link size and weight.

Numerous sausage samples were made by varying the collagen/polysaccharide gel solids between 7% and 8% by weight; the “G” content of the alginate between 32% and 50%; the weight of the casing between 5, 5.3, 5.5 and 7%; thc amount of EDTA between 0, 110, 150, 220, 250, 350, 515, 1148, and 1150 ppm; the amount of crosslinking agent added to the collagen between 0, 515, 1150, and 3000 ppm of hydroxyacetaldehyde; and the calcium source between calcium lactate and calcium chloride. The following examples are representative of the numerous casings made and tested.

The following Table II contains Examples 1-29. The examples are directed a sausage having a collagen/alginate casing coextruded over a meat core. The collagen/alginate gel contains the following ingredients, unless stated differently in Table II. The pork sausage encased with the collagen/alginate gels were tested for % yield, residue, and bite.

Total gel solids =7% (by weight),

% G=50,

Casing Layer=7.0% (by weight of total sausage),

Glycerin=0% (by weight),

Cellulose=1% (by weight),

Alginate/collagen ratio=2/5 (29% alginate)

TABLE II
Comparison of Variables in Co-extrusion of Fresh Pork Sausage

| Example | Gel | Casing | | EDTA, | XL, | Calcium | | | Yield, | | | |
|---|---|---|---|---|---|---|---|---|---|---|---|---|
| No. | Solids, % | Layer, wt % | G, % | ppm | ppm¹⁾ | salt²⁾ | Glycerin | CellOH³⁾ | % | Residue | Bite | CR⁴⁾ |
| 1 | 7.0 | 7.0 | 41 | 0 | 0 | 1 | 0 | 0.50 | 78 | 5.00 | 3.0 | 5.5 |
| 2 | 7.0 | 7.0 | 50 | 0 | 0 | 2 | 0 | 0.50 | 74 | 3.00 | 2.0 | 4.3 |
| 3 | 7.0 | 7.0 | 50 | 1100 | 0 | 1 | 0 | 0.50 | 87 | 8.50 | 5.0 | 7.6 |
| 4 | 7.0 | 7.0 | 50 | 1100 | 0 | 2 | 0 | 0.50 | 83 | 6.50 | 3.5 | 6.3 |
| 5 | 7.0 | 7.0 | 41 | 1100 | 1150 | 1 | 0 | 0.00 | 91 | 9.50 | 3.0 | 7.4 |
| 6 | 7.0 | 7.0 | 50 | 500 | 1150 | 1 | 0 | 0.50 | 79 | 7.00 | 4.0 | 6.5 |
| 7 | 7.0 | 7.0 | 50 | 1100 | 1150 | 1 | 25 | 0.25 | 89 | 9.50 | 5.0 | 8.0 |
| 8 | 7.0 | 7.0 | 50 | 1100 | 575 | 1 | 25 | 0.5 | 85 | 8.50 | 4.0 | 7.2 |
| 9 | 7.0 | 7.0 | 50 | 1100 | 1150 | 1 | 0 | 0.5 | 84 | 8.50 | 4.0 | 7.2 |
| 10 | 7.0 | 7.0 | 50 | 1100 | 1150 | 1 | 25 | 1.00 | 77 | 7.00 | 4.0 | 6.4 |
| 11 | 7.0 | 7.0 | 50 | 0 | 1150 | 1 | 25 | 0.25 | 76 | 5.00 | 4.0 | 5.7 |
| 12 | 7.0 | 7.0 | 50 | 0 | 1150 | 1 | 25 | 1.00 | 79 | 5.00 | 2.0 | 5.2 |
| 13 | 7.0 | 7.0 | 50 | 0 | 1150 | 1 | 25 | 1.00 | 79 | 6.00 | 2.5 | 5.7 |
| 14 | 7.0 | 7.0 | 65 | 1100 | 1150 | 1 | 0 | 1.00 | 76 | 7.00 | 3.0 | 6.1 |
| 15 | 7.0 | 7.0 | 50 | 1100 | 1150 | 2 | 25 | 0.00 | 94 | 8.00 | 4.0 | 7.4 |
| 16 | 7.0 | 7.0 | 50 | 1100 | 1150 | 1 | 40 | 0.00 | 94 | 9.50 | 5.1 | 8.2 |
| 17 | 7.0 | 7.0 | 50 | 1100 | 1150 | 1 | 25 | 0.00 | 93 | 10.00 | 5.5 | 8.5 |
| 18 | 7.0 | 7.0 | 50 | 1100 | 1150 | 1 | 13 | 0.00 | 92 | 9.50 | 5.5 | 8.3 |
| 19 | 7.0 | 7.0 | 41 | 1100 | 1150 | 1 | 0 | 0.00 | 91 | 9.50 | 5.3 | 8.2 |
| 20 | 7.0 | 7.0 | 50 | 1100 | 1150 | 1 | 0 | 0.50 | 80 | 8.50 | 4.3 | 7.1 |
| 21 | 7.0 | 7.0 | 50 | 1100 | 1150 | 1 | 25 | 0.50 | 85 | 8.50 | 4.6 | 7.4 |
| 22 | 7.0 | 7.0 | 50 | 1100 | 1150 | 2 | 25 | 0.50 | 81 | 6.50 | 4.0 | 6.4 |
| 23 | 7.0 | 7.0 | 50 | 2200 | 1150 | 1 | 25 | 0.00 | 87 | 8.50 | 5.0 | 7.6 |
| 24 | 7.0 | 7.0 | 65 | 2200 | 0 | 1 | 25 | 0.00 | 96 | 8.00 | 5.0 | 7.8 |
| 25 | 9.0 | 7.0 | 50 | 1100 | 3000 | 1 | 25 | 0.00 | 96 | 8.00 | 5.0 | 7.8 |
| 26 | 7.0 | 5.5 | 50 | 1100 | 3000 | 1 | 25 | 0.00 | 96 | 8.00 | 5.5 | 7.9 |
| 27 | 7.0 | 4.0 | 41 | 1100 | 1150 | 1 | 25 | 0.00 | 89 | 8.00 | 3.0 | 6.9 |
| 28 | 7.0 | 7.0 | 41 | 1100 | 1150 | 1 | 25 | 0.00 | 91 | 9.00 | 6.0 | 8.3 |
| 29 | 7.0 | 7.0 | 41 | 1100 | 1150 | 1 | 25 | 0.00 | 88 | 8.50 | 4.0 | 7.3 |

¹⁾ppm of glutaraldehyde,
²⁾lactate = 1, chloride = 2,
³⁾cellulose, and
⁴⁾CR is combined results of % yield, residue, and bite, calculated as follows:
$CR = ( 0.10 ) ( \frac{\% yield}{3} ) + ( \frac{residue}{3} ) + ( \frac{bite}{3} )$

### EXAMPLE 30

Examples 1-29 were repeated, except the following ingredients were present in the collagen/alginate gel.

Total gel solids=9%,

Crosslinker=0 ppm,

% G=65,

Casing Layer=8.0%,

EDTA=3300 ppm,

Glycerin=0%,

Calcium lactate,

Cellulose=1.25%.

The results were:

Yield=87%;

Residual=8.0

Bite=8.3

### EXAMPLE 31

Examples 1-29 were repeated, except the following ingredients were present in the collagen/alginate gel.

Total gel solids=7%,

Crosslinker=0 ppm,

% G=65,

Casing Layer=9.0%,

EDTA=3300 ppm,

Glycerin=0%,

Calcium chloride,

Mineral oil=0.5%,

Cellulose=1.25%.

The results were:

Yield=76%;

Residual=7.5

Bite=4.0

### EXAMPLE 32

Examples 1-29 were repeated, except the following ingredients were present in the collagen/alginate gel.

Total gel solids=7%,

Crosslinker=0 ppm,

% G=65,

Casing Layer=9.0%,

EDTA=3300 ppm,

Glycerin=0%,

Calcium chloride,

Mineral oil=0.5%,

Cellulose=1.25%.

The results were:

Yield=76%;

Residual=7.5

Bite=4.0

### EXAMPLE 33

Examples 1-29 were repeated, except the following ingredients were present in the collagen/alginate gel.

Total gel solids=7%,

Crosslinker=0 ppm,

% G=65,

Casing Layer=9.0%,

EDTA=330 ppm,

Glycerin=0%,

Calcium chloride,

Mineral oil=1.0%,

Cellulose=1.25%.

The results were:

Yield=88%;

Residual=7.5;

Bite=5.5.

### EXAMPLE 34

Examples 1-29 were repeated, except the following ingredients were present in the collagen/alginate gel.

Total gel solids=7%,

Crosslinker=15,000 ppm,

% G=43,

Casing Layer=7.0%,

EDTA=800 ppm,

Glycerin=2.5%,

Calcium chloride,

Cellulose=1.0%.

The results were:

Yield=84%;

Residual=5.5;

Bite=4.0.

### EXAMPLE 35

Examples 17 was repeated, but rather than griddle frying, the sausages were deep fried in oil by immersion for 1.75 minutes at 375° F. commercial vegetable oil. The yield and residue measurements are meaningless in this example, but bite was excellent and rated at 7.0. The sausages were esthetically very attractive.

### EXAMPLE 36

Example 17 was repeated, except that the sausage was cooked in an impingement oven at 450° F. for 2 minutes. The yield was 77% and bite was 4.

### EXAMPLE 37

Example 17 was repeated, except that the sausage was cooked in a convection oven at 450° F. for 2 minutes. The yield was 91.2% and bite was 5.0.

### EXAMPLE 38

Example 17 was repeated, except that the sausages were roasted over an open flame for 2 minutes. The yield was 86% and bite was 5.

### EXAMPLES 39-49

Example 17 was repeated. The sausages were tested, however, after slacking at 40° F. for 1, 4, 7, and 12 days. The results are summarized in the following Table III.

### Griddle Frying Stability of the Fresh Pork Sausages Over Time

TABLE III

| | % yield | | | | residue | | | | bite | | | |
|---|---|---|---|---|---|---|---|---|---|---|---|---|
| Example | 1 | 4 | 7 | 12 | 1 | 4 | 7 | 12 | 1 | 4 | 7 | 12 |
| No. | day⁵⁾ | days | days | days | day | days | days | days | day | days | days | days |
| 39 | 87.0 | 81.1 | 85.3 | 77.8 | 8.0 | 8.0 | 7.0 | 5.0 | 4.5 | 3.0 | 4.0 | 4.0 |
| 40 | 84.6 | 81.9 | 88.1 | 81.4 | 8.0 | 6.0 | 6.0 | 4.5 | 4.5 | 3.0 | 5.0 | 4.0 |
| 41 | 90.4 | 89.4 | NA | NA | 6.0 | 7.5 | NA | NA | 3.0 | 2.5 | NA | NA |
| 42 | 89.3 | 85.0 | 85.3 | 88.4 | 6.0 | 7.0 | 3.0 | 5.0 | 3.0 | 3.0 | 3.0 | 3.0 |
| 43 | 83.1 | 89.4 | 82.7 | 84.4 | 8.0 | 7.0 | 8.0 | 8.0 | 4.5 | 2.0 | 6.0 | 5.0 |
| 44 | 86.8 | 84.6 | 91.9 | 87.2 | 9.0 | 7.0 | 7.5 | 7.0 | 4.8 | 4.0 | 3.0 | 3.5 |
| 45 | 88.4 | 87.0 | 85.2 | 86.1 | 7.0 | 10.0 | 6.0 | 6.0 | 4.0 | 3.0 | 3.0 | 3.5 |
| 46 | 86.8 | 93.5 | 86.9 | 87.2 | 6.5 | 9.0 | 5.0 | 5.0 | 2.5 | 2.5 | 3.0 | 3.0 |
| 47 | 85.1 | 81.4 | 90.8 | 83.5 | 8.5 | 9.5 | 8.0 | 6.0 | 5.0 | 5.0 | 5.5 | 4.5 |
| 48 | 85.5 | 91.0 | 88.7 | 87.3 | 8.0 | 9.0 | 8.0 | 7.0 | 5.0 | 2.0 | 5.5 | 4.0 |
| 49 | 88.1 | 90.6 | 94.5 | 88.9 | 9.5 | 9.0 | 8.0 | 9.0 | 5.0 | 4.0 | 5.5 | 5.5 |

⁵⁾days of slack time.

### EXAMPLE 50

The following Table IV contains an additional thirty runs of pork sausage encased with a collagen/alginate gel.

TABLE IV

| | Gel Solids | Xlinker | G Alginate | Casing Layer | EDTA | Glycerin | |
|---|---|---|---|---|---|---|---|
| Run | (%) | (ppm) | (%) | (%) | (ppm) | (%) | Ca Salt |
| 1 | 8 | 0 | 32 | 7 | 250 | 0 | lactate |
| 2 | 7 | 3300 | 50 | 5 | 250 | 25 | lactate |
| 3 | 8 | 0 | 50 | 7 | 250 | 0 | chloride |
| 4 | 7 | 3300 | 50 | 5 | 250 | 0 | chloride |
| 5 | 7 | 0 | 32 | 5 | 250 | 25 | lactate |
| 6 | 7 | 0 | 50 | 5 | 0 | 25 | lactate |
| 7 | 8 | 0 | 50 | 5 | 250 | 0 | lactate |
| 8 | 7 | 3300 | 32 | 5 | 0 | 25 | chloride |
| 9 | 7 | 0 | 50 | 5 | 0 | 0 | chloride |
| 10 | 8 | 0 | 32 | 5 | 0 | 25 | chloride |
| 11 | 7 | 0 | 32 | 7 | 250 | 25 | chloride |
| 12 | 8 | 0 | 50 | 7 | 250 | 25 | lactate |
| 13 | 7 | 0 | 32 | 7 | 0 | 25 | lactate |
| 14 | 7 | 3300 | 50 | 5 | 0 | 0 | lactate |
| 15 | 8 | 3300 | 32 | 7 | 0 | 25 | chloride |
| 16 | 8 | 3300 | 50 | 7 | 250 | 25 | chloride |
| 17 | 7 | 0 | 50 | 7 | 0 | 25 | chloride |
| 18 | 8 | 3300 | 32 | 5 | 250 | 25 | chloride |
| 19 | 8 | 3300 | 32 | 7 | 0 | 0 | lactate |
| 20 | 8 | 0 | 32 | 5 | 250 | 0 | chloride |
| 21 | 8 | 3300 | 50 | 7 | 250 | 0 | lactate |
| 22 | 7 | 0 | 50 | 7 | 250 | 0 | lactate |
| 23 | 7 | 0 | 32 | 7 | 0 | 0 | chloride |
| 24 | 8 | 3300 | 32 | 5 | 0 | 25 | lactate |
| 25 | 8 | 0 | 50 | 7 | 0 | 0 | lactate |
| 26 | 7 | 3300 | 32 | 5 | 250 | 0 | lactate |
| 27 | 7 | 3300 | 50 | 7 | 0 | 0 | chloride |
| 28 | 8 | 3300 | 32 | 5 | 0 | 0 | chloride |
| 29 | 8 | 3300 | 50 | 5 | 0 | 25 | chloride |
| 30 | 7 | 3300 | 32 | 7 | 250 | 25 | lactate |

The following Table V summarizes results expected for % yield, residual, and bite for collagen/alginate casings having the following parameters. These predicted results were calculated from a series of tests using the different collagen/alginate gels of Table IV that altered the indicated variables according to the following table, and the results were analyzed by computer.

TABLE V

| Gel Solids | G Alginate | Casing layer | EDTA | Glycerin | | % | | |
|---|---|---|---|---|---|---|---|---|
| % | % | % | ppm | % | Ca Salt | Yield | Residual | Bite |
| 7 | 50 | 5 | 350 | 30% | Lactate | 87.3 | 7.2 | 3.7 |
| 7 | 32 | 5 | 350 | 30% | Lactate | 89.1 | 8.8 | 3.6 |
| 7 | 32 | 5 | 150 | 20% | Lactate | 81.4 | 7.8 | 3 |
| 8 | 50 | 7 | 0 | 0% | Chloride | 72.1 | 5.4 | 0.4 |
| 8 | 32 | 7 | 0 | 0% | Chloride | 69.1 | 3.1 | 0.1 |

Note that the % yield, residual, and bite are inferior for collagen/alginate blends free of EDTA

The collagen/polysaccharide casings of the present invention can be prepared, shirred, and stuffed at a later date, or a present casing can be prepared in a coextrusion method wherein a collagen/polysaccharide gel is coextruded onto a meat product and set on the meat product by contact with a calcium ion source comprising calcium lactate.

The present casings can be used the preparation of all types of sausages, including, but not limited to, pork, beef, turkey, and breakfast sausages. The present casings also can be used on vegetable-based encased foodstuffs.

It can be appreciated by those skilled in the art, that it is not the intention to, in any way, limit the specific energy sources or cooking method or configuration that are suitable for cooking the sausages made by the present process. For example, the encased sausages produced by the presently claimed invention can be cooked any mariner, including pan frying, impingement or convection heating, steaming, deep frying, microwaving, and other currently available methods.

1. A casing for a foodstuff comprising:
(a) about 1% to about 7%, by weight, of a polysaccharide;
(b) about 1% to about 7%, by weight, of a collagen; and
(c) water,
wherein the collagen has an amide nitrogen number of about 1.0 to about 2.2.

2. The casing of claim 1 wherein a weight ratio of collagen to polysaccharide is from about 90:10 to about 30:70, on a dry weight basis.

3. The casing of claim 1 wherein a weight fraction of collagen in the collagen/polysaccharide blend is 1.2 to 2.5 times greater than a weight fraction of polysaccharide.

4. The casing of claim 1 wherein the polysaccharide comprises an alginate.

5. The casing of claim 1 wherein the amide nitrogen number of the collagen is about 1.1 to about 2.1.

6. The casing of claim 1 wherein the amide nitrogen number of the collagen is about 1.2 to about 2.0.

7. A foodstuff comprising a meat or vegetable product encased in a casing of claim 1.

8. The foodstuff of claim 7 wherein the foodstuff is a sausage.

9. The foodstuff of claim 8 wherein the sausage comprises one or more of pork, beef, turkey, and vegetables.

10. The foodstuff of claim 9 wherein the sausage is a breakfast sausage.

11. A casing for a foodstuff prepared by:
(a) adding a polysaccharide to an aqueous collagen gel having an amide nitrogen number of about 1.0 to about 2.2, while maintaining a pH of a resulting collagen/polysaccharide blend between about 3.9 and about 5.5;
(b) extruding the collagen/polysaccharide blend to form a casing; and
(c) contacting the casing with an aqueous salt solution.

12. The casing of claim 11 wherein the salt solution comprises a calcium salt.

13. The casing of claim 11 wherein the collagen/polysaccharide blend is coextruded with a meat or vegetable product, wherein the meat or vegetable product is extruded through a center port and the collagen/polysaccharide blend is extruded through an annular port surrounding the center port.

14. The casing of claim 11 wherein the polysaccharide comprises an alginate.

15. The casing of claim 11 wherein the alginate comprises sodium alginate.

16. The casing of claim 11 wherein the pH is maintained between 3.9 and 4.6.

17. The casing of claim 16 wherein the aqueous collagen gel has an amide nitrogen number of about 1.1 to about 2.1.

18. The casing of claim 1 further comprising about 10 to about 1500 ppm, by weight, of an aminocarboxylic acid or salt thereof.
